(19) United States
(12) Patent Application Publication
(10) Pub. No.: US 2009/0181352 A1
(43) Pub. Date: Jul. 16, 2009

(54) MULTIPLE STUDENT BEHAVIOR COUNTER

(76) Inventor: Pauline Hood, Sandy, UT (US)

Correspondence Address: ADVANTIA LAW GROUP, 9035 SOUTH 1300 EAST, SUITE 200, SANDY, UT, 84094, US

(21) Appl. No.: 12/332,869

(22) Filed: Dec. 11, 2008

Related U.S. Application Data
(60) Provisional application No. 61/021,244, filed on Jan. 15, 2008.

(51) Int. Cl. G09B 5/00

(52) U.S. Cl. 434/309; 434/308

(57) ABSTRACT

A multiple student behavior counter device configured to display and store student data, wherein the device includes a housing. The housing includes a display module coupled to the housing. The device also includes an instructional module coupled to the display module and configured to store student data. The instructional module includes a communication module configured to send or receive student data. In addition, the instructional module includes a storage module configured to store student data. The storage module is selectably removable from the device. Furthermore, the instructional module includes a teaching module configured to store teaching lesson plans for an instructor. The device further includes a data entry module in communication with the instructional module, wherein the data entry module may be configured to enter student data to the instructional module. The device also includes an audio module in communication with the instructional module and configured to display audio.

### CROSS-REFERENCE TO RELATED APPLICATIONS

This invention claims priority, under 35 U.S.C. § 120, to the U.S. Provisional Patent Application No. 61/021,244 to Hood filed on Jan. 15, 2008, which is incorporated by reference herein.

### BACKGROUND OF THE INVENTION

1. Field of the Invention

The present invention relates to hand held devices, specifically a multiple student behavior counter device configured to display and store student data.

2. Description of the Related Art

Teaching techniques and apparatus have only recently begun to be intensively and extensively developed. Up to about the 1940's, teaching was conventionally done by presenting material in a classroom environment, wherein a number of students were assembled, and were orally instructed as a group by an instructor or teacher. Often books or the like were provided and the students were expected to initially learn the instructional material from the books, which material was reviewed and amplified by the instructor at a subsequent session of the class. As children progress through the school system, the instructional material is presented over a longer period of time to the class, so that at the high school and college levels, the instructional material is presented by means of lectures, usually lasting 50 minutes. Underlying the above educational practice is the noted principle that younger students generally have relatively short attention spans. Classroom instruction was geared therefore, to provide instruction for a period of time related to the assumed attention span of the ages of the group of students being instructed. In addition, high school and college curriculum employ the use of computers to assist students throughout the learning process. However, teachers do not have the ability to assign homework, record, send, and store student statistics and interactions. Some improvements have been made in the field. Examples of references related to the present invention are described below, and the supported teachings of each reference are incorporated by reference herein:

U.S. Pat. No. D547,873, issued to Hood, discloses an ornamental design for behavior observation counter.

U.S. Pat. No. 3,656,243, issued to Segal et al., discloses an improved classroom response system of the type wherein a number of students are provided with individual responders each having a plurality of switches selectively operable to indicate the student's choice of response to a question or other stimulus. The invention is directed to novel methods and apparatus for performing arithmetic operations and displays which make available to the instructor information helpful in conducting the class and otherwise simplify instructional tasks. Included are means for automatically indicating which of several responses is “correct” by determining the response to which the highest weight has been assigned by the instructor. Also disclosed are novel means to calculate each individual student's cumulative score and to indicate automatically the students whose scores fall below a preselected acceptable percentage of the maximum possible score. Displays of the total number of students responding to a given question, and the percent of the class which has responded with any of the possible choices are provided.

U.S. Pat. No. 3,685,169, issued to Blau et al., discloses a method of teaching wherein the span of attention of a student is determined by presenting the student with informational material and related questions in successive time periods, counting the number of questions answered and the number of erroneous answers in successive timer periods to determine when a significant increase in errors occurs, and thereafter presenting instructional material to the student only for his thus determined attention span. An apparatus including means for presenting instructional material and questions, means for counting questions and errors, and means for timing.

U.S. Pat. No. 3,748,754, issued to LaBerge, discloses a machine and a method of machine operation for teaching and testing identification and comprehension of stimulus patterns and to improve the speed of doing same by providing a repeated presentation of target symbols, corresponding to an initial cue symbol, to which the student is expected to respond positively, and occasional catch symbols to which the student is to make no response, and thereafter providing an immediate readout indicating the performance on a test run for the student and instructor. The system measures performance in terms of the average response time for correct responses and the number of correct responses as well as the number of incorrect responses. The immediate readout of student performance is provided so that particular learning difficulties may be identified at once and allow the student to correct his particular problem, thereby optimizing his learning rate. The subject's performance on new material is compared against his performance on well-learned material over a period of practice to indicate progress made.

U.S. Pat. No. 4,179,611, issued to Mill et al., discloses a self-contained piece of electronic equipment for monitoring the progress of a processing operation (e.g. production from a machine) and in its preferred embodiments gives digital displays of achievement and target counts for the monitored operation as well as a constantly updated performance rating based on a ratio of true achievement.

U.S. Pat. No. 4,179,822, issued to Clark III, discloses a console adapted to be interconnected to a computer for administering a test in which the questions have plural answers. After selecting a number of answers equal to the number of correct answers to a question, the student is informed of the number of incorrect answers and afforded an opportunity to complete the answer. This process is repeated until all of the correct answers have been identified and the number of errors in identifying the correct answers is utilized to indicate the student's score. A display of the rate of progression through the test is updated after each question is answered. A method of administering the test of plural answer questions as well as methods of scoring the test are also disclosed.

U.S. Pat. No. 4,375,080, issued to Barry et al., discloses a recording and evaluating instrument and method for teacher evaluation, observation and the recording of classroom activities is prompted by a display device controlled by an interval timer, the timing interval of which is preselected by the observer. The observer depresses a key of a keyboard corresponding to the observed activity. A computer receives the observer's keyboard entry, and supplies the information to a control circuit which controls the operation of a stylus mechanism and a paper advance mechanism for providing a complete and permanent record of consecutive observed activities. The computer also counts the number of observed and recorded activities, and determines the percentage of activities corresponding to each of a plurality of predetermined activity categories. At the end of the period of evaluation, the number of observed and recorded activities and the percentages in each category are displayed by a numeric display device.

U.S. Pat. No. 4,012,852, issued to Journot et al., discloses an electronic speech therapy teaching apparatus for use by a speech therapist includes a silent timer with an associated electronic digital display, an adjustable aural speech rate device, an automatic calculator for computing a student's percentage of correct responses, an electronic display of the accumulation of total and correct responses, and controls to select and operate the various features of the apparatus. The silent timer selectively counts up or down, informing the operator when counting down, through an audio/visual alarm, when a predetermined time period has expired. The adjustable aural speech rate device produces tones at a rate appropriate for the speech student. Manually controlled switches enable the operator to register and display the number of correct and total responses during the evaluation procedure. An automatic computer calculates the percentage of a student's correct responses as they are registered by the operator.

U.S. Pat. No. 5,289,521, issued to Coleman et al., discloses a control unit device and system is provided that allows a verbally handicapped person or normal young child to interact with a remote speech development computer system to assist in the development of verbal communications and cognitive skills. The electronic circuit of the control unit provides an interface to a standard telephone network that allows communications with the remote computer system. The remote computer system consists of a high quality speech synthesizer with a telephone interface, a personal computer, and a controlling software program that contains the speech development exercises. The control unit electronic circuit further provides audio reproduction of the synthesized voice of the remote computer, DTMF (dual tone multiple frequency) tone decoding to control output devices as commanded by the remote computer, and DTMF tone encoding to allow input devices to send signals to the program on the remote computer. The verbally handicapped person interacts with the system through two switch pads on the control unit or through an expansion switch board that interfaces to an expansion port on the control unit. The keypad on a standard DTMF telephone is used by a speech pathologist or therapist to setup and control the speech and cognitive skills development programs.

The inventions heretofore known suffer from a number of disadvantages which include being limited in application, being limited in adaptability, being limited in versatility, being expensive, being difficult to use, being bulky, being ineffective, and being unduly complicated.

What is needed is a multiple student behavior counter device that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available multiple student behavior counter device. Accordingly, the present invention has been developed to provide an efficient and effective device and system for displaying and storing student data.

In one embodiment, there is a multiple student behavior counter device configured to display and store student data, wherein the device may include a housing. The housing may include a display module coupled to the housing, wherein the display module may be configured to display student data. The device may also include an instructional module coupled to the display module and configured to store student data. The instructional module may include a communication module configured to send or receive student data. The communication module may include a wireless module configured to send or receive data wirelessly. In addition, the instructional module may include a storage module configured to store student data. The storage module may be selectably removable from the device. Furthermore, the instructional module may include a teaching module configured to store teaching lesson plans for an instructor.

The device may further include a data entry module in communication with the instructional module, wherein the data entry module may be configured to enter student data to the instructional module. In addition, the data entry module may include a touch screen. The device may also include an audio module in communication with the instructional module and configured to display audio.

Reference throughout this specification to features, advantages, or similar language does not imply that all of the features and advantages that may be realized with the present invention should be or are in any single embodiment of the invention.

Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematic representations, not intended to portray specific parameters of the invention. Understanding that these drawing(s) depict only typical embodiments of the invention and are not, therefore, to be considered to be limiting its scope, the invention will be described and explained with additional specificity and detail through the use of the accompanying drawing(s), in which:

FIG. 1 is a top perspective view of a multiple student behavior counter device, according to one embodiment of the invention;

FIG. 2 is a top perspective view of a multiple student behavior counter device, according to one embodiment of the invention; and

FIG. 3 is a block diagram of an instruction module of a multiple student behavior counter device, according to one embodiment of the invention.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will, nevertheless, be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like.

Modules may also be implemented in software for execution by various types of processors. An identified module of programmable or executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module and/or a program of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The various system components and/or modules discussed herein may include one or more of the following: a host server or other computing systems including a processor for processing digital data; a memory coupled to said processor for storing digital data; an input digitizer coupled to the processor for inputting digital data; an application program stored in said memory and accessible by said processor for directing processing of digital data by said processor; a display device coupled to the processor and memory for displaying information derived from digital data processed by said processor; and a plurality of databases. Various databases used herein may include: instruction tables, behavior journals, assignment tables, goals tables, objective tables and/or like data useful in the operation of the present invention. As those skilled in the art will appreciate, any computers discussed herein may include an operating system (e.g., Windows Vista, NT, 95/98/2000, OS2; UNIX; Linux; Solaris; MacOS; and etc.) as well as various conventional support software and drivers typically associated with computers. The computers may be in a home or business environment with access to a network. In an exemplary embodiment, access is through the Internet through a commercially-available web-browser software package.

The present invention may be described herein in terms of functional block components, screen shots, user interaction, optional selections, various processing steps, and the like. Each of such described herein may be one or more modules in exemplary embodiments of the invention. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, the software elements of the present invention may be implemented with any programming or scripting language such as C, C++, Java, COBOL, assembler, PERL, Visual Basic, SQL Stored Procedures, AJAX, extensible markup language (XML), with the various algorithms being implemented with any combination of data structures, objects, processes, routines or other programming elements. Further, it should be noted that the present invention may employ any number of conventional techniques for data transmission, signaling, data processing, network control, and the like. Still further, the invention may detect or prevent security issues with a client-side scripting language, such as JavaScript, VBScript or the like.

Additionally, many of the functional units and/or modules herein are described as being “in communication” with other functional units and/or modules. Being “in communication” refers to any manner and/or way in which functional units and/or modules, such as, but not limited to, computers, laptop computers, PDAs, modules, and other types of hardware and/or software, may be in communication with each other. Some non-limiting examples include communicating, sending, and/or receiving data and metadata via: a network, a wireless network, software, instructions, circuitry, phone lines, internet lines, satellite signals, electric signals, electrical and magnetic fields and/or pulses, and/or so forth.

As used herein, the term “network” may include any electronic communications means which incorporates both hardware and software components of such. Communication among the parties in accordance with the present invention may be accomplished through any suitable communication channels, such as, for example, a telephone network, an extranet, an intranet, Internet, point of interaction device (point of sale device, personal digital assistant, cellular phone, kiosk, etc.), online communications, off-line communications, wireless communications, transponder communications, local area network (LAN), wide area network (WAN), networked or linked devices and/or the like. Moreover, although the invention may be implemented with TCP/IP communications protocols, the invention may also be implemented using IPX, Appletalk, IP-6, NetBIOS, OSI or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997), the contents of which are hereby incorporated by reference.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment, or example, is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

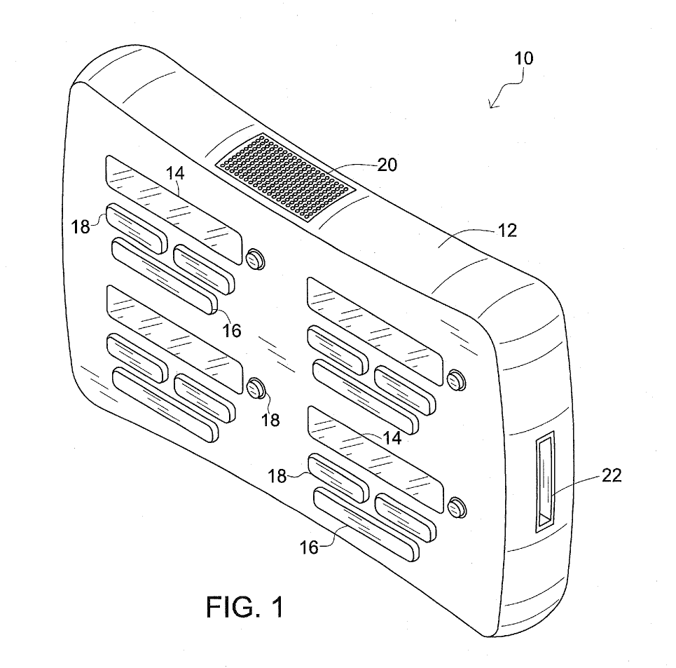

FIG. 1 illustrates a multiple student behavior counter device 10, according to one embodiment of the invention, wherein the device 10 includes a housing 12. The housing 12 includes a display module 14 coupled to the housing, wherein the display module 14 is configured to display student data. One non-limiting example may be a display module as described in U.S. Pat. No. 4,141,003, issued to Felsenstein, which is incorporated for its supported teachings herein. As illustrated in FIG. 1, the device 10 includes a plurality of display modules 14 configured to display student data for a plurality of students. The device 10 also includes a data entry module 16, wherein the data entry module 16 is configured to enter student data. The data entry module 16 includes a plurality of toggle switches 18 configured to enter student data. One non-limiting example of a data entry module may be an electronic device and control means as described in U.S. Pat. No. 6,487,396, issued to Sassi, which is incorporated for its supported teachings herein. The device 10 additionally includes an audio module 20 configured to display audio. Furthermore, the device 10 includes a storage module 22 configured to store student data, wherein the storage module 22 is selectably removable.

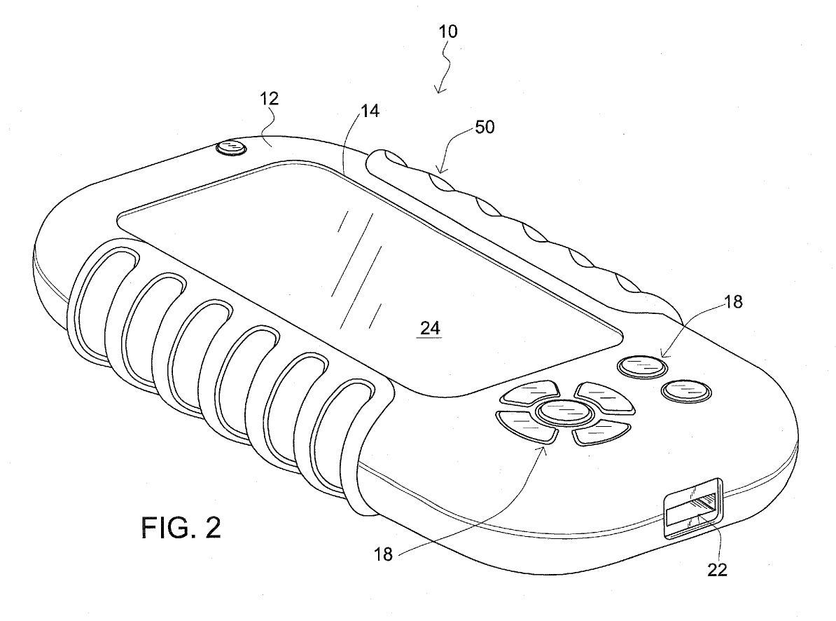

FIG. 2 illustrates a multiple student behavior counter device 10, according to one embodiment of the invention, wherein the device 10 includes a housing 12. The housing includes a display module 14 coupled to the housing 12, wherein the display module 14 is configured to display student data. The device 10 includes a data entry module 16, wherein the data entry module is configured to enter student data. As illustrated in FIG. 2, the data entry module 16 includes a touch screen 24 in communication with the display module 14. In addition, the data entry module 16 includes a plurality of toggle switches 18 configured to enter student data. Furthermore, the device 10 includes a storage module 22 configured to store student data, wherein the storage module 22 is selectably removable. The device 10 also includes a plurality of support members 50 disposed on the housing 12, configured to help support the device 10 when in an user's hand.

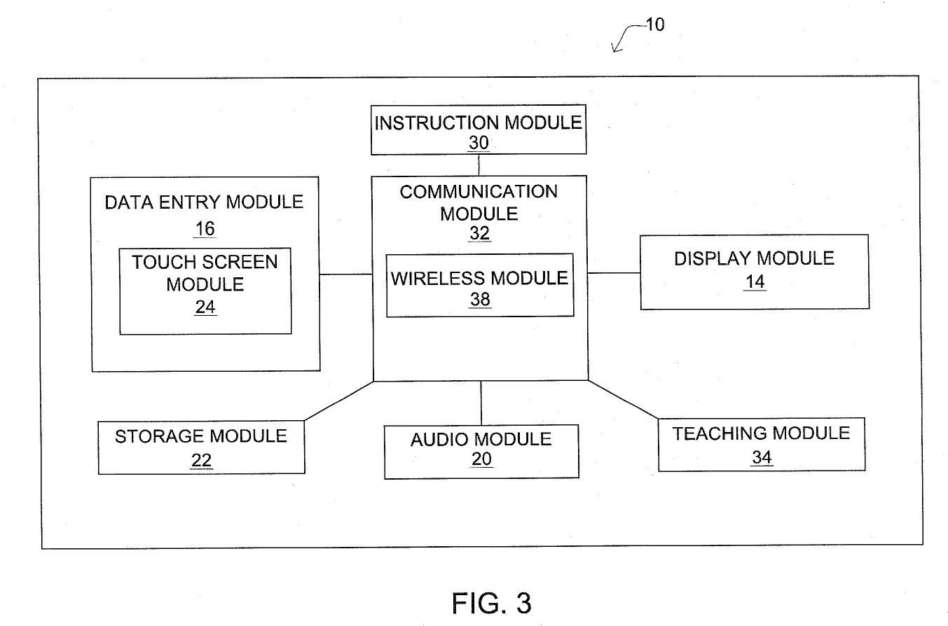

FIG. 3 illustrates a multiple student behavior counter device 10, according to one embodiment of the invention, wherein the device 10 includes an instructional module 30. The instructional module 30 is in communication with the display module 14, wherein the instructional module 30 is configured to send, store, and/or receive student data. The instructional module 30 is in communication with a communication module 32, wherein the communication module 32 is configured to send or receive student data. The communication module 32 includes a wireless module 38, wherein the wireless module 38 enables the communication module 32 to send or receive data wirelessly. In addition, the instructional module 30 in communication with a storage module 34 through the communication module 32, wherein the storage module 34 is configured to store student data.

As illustrated in FIG. 3, the device 10 includes a display module 14 configured to display student data. The display module 14 is in communication with the instruction module 30 through the communication module 32. The device 10 also includes a data entry module 16, wherein the data entry module includes a touch screen module 24, configured to enter student data to the device 10. The data entry module 16 is in communication with the instruction module 30 and the display module 14 through the communication module 32. The device 10 further includes a teaching module 34 configured to store teaching lesson plans for an instructor. The teaching module 34 also includes stored student data and stored student records. In addition, the teaching module 34 includes goal and objective lesson plans for an instructor. The teaching module 34 is in communication with the instruction module 30 through the communication module 32. Furthermore, the device 10 includes an audio module 20 in communication with the instruction module 30, and configured to display audio.

In operation of one embodiment of a multiple student behavior counter device, an instructor operates the counter device by manipulating the plurality of toggle switches. The instructor toggles through the plurality of toggle switches 18 to display a plurality of student data about the display modules. The instructor then selects a lesson plan to instruct the plurality of students and then instructs the students. The instructor records student answers to questions proposed throughout the lesson plan template and enters the student data into the counter device. At the end of the lesson plan the instructor reviews the student data recorded in the counter device and evaluates the student's individual effort. The instructor then uploads the student data into a system network. The system network is viewable to instructors, parents, administration over the internet.

In operation of another embodiment of a multiple student behavior counter device, an instructor operates the counter device by manipulating the touch screen and the plurality of toggle switches. The instructor toggles through the touch screen and the plurality of toggle switches 18 to display a plurality of student data about the display module. The instructor then selects a lesson plan and/or students through template selection to instruct the plurality of students and then instructs the students. The instructor records student answers to questions proposed throughout the lesson plan and/or records observations regarding student behavior as indicated through student and/or plan template(s) and enters the student data into the counter device. At the end of the lesson plan the instructor reviews the student data recorded in the counter device and evaluates the student's individual effort. The instructor then uploads the student data into a system network. The system network is viewable to instructors, parents, administration over the internet. The system network may conditionally update one or more templates based on data uploaded. For example, where a particular student's recorded behavior crosses a defined threshold, a template may be altered (by machine and/or selectably by a professional through the system) such that in another session a different focus/questions/observation may be prompted.

In operation in yet another embodiment of a multiple student behavior counter, a special education instructor, such as but not limited to a speech/language pathologist, wherein the instructor observes and records student behavior during a period of time. The instructor selects a lesson plan and instructs the students; the instructor records student behavior throughout the lesson plan and records the data in the counter device. The data recorded in the counter device populates report templates regarding student behavior and record. The data is then transmitted to a central database or to instructors, parents, administration, etc.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

For example, although the description describes instructors and students, one skilled in the art would appreciate that the device may be used to, but not limited to, recording the behavior of animals, wherein the device is configured to help animal researchers in the field or in the lab record animal behavior and still perform its intended function.

Additionally, although the figures illustrate a single display module disposed about a front side of the device, one skilled in the art would appreciate that the device may include a second display module disposed about a back side of the device and configured to display visual aids regarding the lesson plans to the students, wherein the device would still perform its intended function.

It is expected that there could be numerous variations of the design of this invention. An example is that the display module, toggle switches, and housing may vary in size, shape, length, width, height, design, configuration, and color, and still perform its intended function.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of or to consist essentially of one or more of the features, functions, structures, methods described herein.

What is claimed is:

1. A multiple student behavior counter device configured to display and store student data, comprising:
a) a housing;
b) a display module coupled to the housing, configured to display student data;
c) an instructional module coupled to the display module configured to store student data, comprising:
c1) a communication module configured to send or receive student data;
c2) a storage module configured to store student data; and
c3) a teaching module configured to store teaching lesson plans for an instructor; and
d) a data entry module in communication with the instructional module configured to enter student data to the instructional module.

2. The device of claim 1, wherein the device further includes an audio module in communication with the instructional module and configured to display audio.

3. The device of claim 1, wherein the storage module is selectably removable.

4. The device of claim 1, wherein the communication modules further includes a wireless module configured to send or receive data wirelessly.

5. The device of claim 1, wherein the data entry module further includes a touch screen.

6. The device of claim 1, wherein the instructional module uploads student data to a network daily.

7. A multiple student behavior counter system configured to display and store student data, comprising:
a) a housing;
b) a display module coupled to the housing, configured to display student data;
c) an instructional module coupled to the display module configured to store student data, comprising:
c1) a communication module configured to send or receive student data;
c2) a storage module configured to store student data; and
c3) a teaching module configured to store teaching lesson plans for an instructor; and
d) a data entry module in communication with the instructional module configured to enter student data to the instructional module.

8. The system of claim 7, wherein the device further includes an audio module in communication with the instructional module and configured to display audio.

9. The system of claim 8, wherein the storage module is selectably removable.

10. The system of claim 9, wherein the communication modules further includes a wireless module configured to send or receive data wirelessly.

11. The system of claim 10, wherein the data entry module further includes a touch screen.

12. The system of claim 11, wherein the instructional module uploads student data to a network daily.

13. A multiple student behavior counter system configured to display and store student data, comprising:
a) a housing;
b) a display module coupled to the housing, configured to display student data;
c) an instructional module coupled to the display module configured to store student data, comprising:
c1) a communication module configured to send or receive student data; wherein the communication modules further includes a wireless module configured to send or receive data wirelessly;
c2) a storage module configured to store student data; wherein the storage module is selectably removable; and
c3) a teaching module configured to store teaching lesson plans for an instructor;
d) a data entry module in communication with the instructional module configured to enter student data to the instructional module; wherein the data entry module further includes a touch screen;
e) an audio module in communication with the instructional module and configured to display audio; and
f) wherein the instructional module uploads student data to a network, daily.
